(19) United States
(12) Patent Application Publication
(10) Pub. No.: US 2023/0356404 A1
(43) Pub. Date: Nov. 9, 2023

(54) OBSERVATIONAL SUPPORT SYSTEMS AND METHODS FOR ROBOTIC PICKING AND OTHER ENVIRONMENTS

(71) Applicant: Plus One Robotics, Inc., San Antonio, TX (US)

(72) Inventors: Shaun Edwards, San Antonio, TX (US); Paul Hvass, San Antonio, TX (US); Daniel Grollman, Lafayette, CO (US); Zach Keeton, San Antonio, TX (US)

(21) Appl. No.: 18/144,814

(22) Filed: May 8, 2023

Related U.S. Application Data
(60) Provisional application No. 63/339,227, filed on May 6, 2022.

(51) Int. Cl. B25J 9/16; G05B 19/4155

(52) U.S. Cl. CPC B25J 9/1697; B25J 9/161; G05B 19/4155; G05B 2219/50391

(57) ABSTRACT

The present disclosure is for systems and methods for providing observational support. The invention comprises an observational support system which generally operates as a supplemental system to an existing automated decision support system, such as a primary vision system for robotic picking operations. The observational support system provides an auxiliary sensor module which is operable to obtain data associated with a pick scene independently of the primary vision system and provide the data to an intervention system for further review and processing. The observational support system is generally called upon in situations where the primary vision system fails or encounters circumstances it cannot handle in a timely manner. The observational support system in combination with the intervention system provides supplemental assistance in these circumstances so that robotic picking operations can continue more readily.

### CROSS-REFERENCE TO RELATED APPLICATIONS

This application claims the benefit of U.S. Provisional Application 63/339,227, filed May 6, 2022, titled “OBSERVATIONAL SUPPORT SYSTEMS AND METHODS FOR ROBOTIC PICKING AND OTHER ENVIRONMENTS,” which is herein incorporated by reference in its entirety.

### BACKGROUND

### Field of the Art

The present invention relates to intervention systems for various applications such as robotic picking, handling, and conveyance systems. More specifically, the present invention relates to a modular intervention system that can integrate into pre-existing and deployed vision systems.

### Discussion of the State of the Art

Automated robotic picking systems often rely on a vision component for performing pick planning and determining how to handle various pick scenarios that arise throughout automated picking operations. In some scenarios the vision system encounters situations where it is unable to make an automated decision and requires additional intervention. At times, a vision system may be able to make an automated decision, however the decision may be associated with a less than desirable confidence level. When this occurs, if robotic picking operations continue in an automated manner, they may be associated with an increased risk of failed picks and/or picking actions which disrupt the pick scene (e.g. knock over pickable objects, pick more than an intended pick object, etc.). Again, these scenarios associated with lower confidence decisions or potential failures would benefit from additional intervention. In other circumstances, a vision system may take too long to respond or process information (e.g. a cloud based system is down, the processing queue for a vision system is backed up, etc.). In these scenarios an alternative to the vision system would be beneficial in assisting the robotic picking system.

In many cases the additional intervention or alternative assistance comes in the form of human intervention, such as a human visiting the picking environment to address the issue. This can significantly delay operations while waiting for a human to arrive. Delays lead to inefficiencies and potentially additional costs and lower revenue as fewer picking operations can be completed in a given time frame.

In some picking environments, remote intervention may be possible, however in order to have remote intervention, the necessary system components and configuration generally need to be pre-planned and fully integrated into an existing picking system/environment for optimal usefulness. Some have tried to solve this problem by integrating a remote assistance system with an existing vision system (e.g. using the same sensors, resources, etc.) after the fact. In many cases, this requires a lot of additional work to retrofit or integrate an intervention system after the fact. In some cases, it may not be possible to retrofit an intervention system to an existing vision system due to limitations in the existing vision system itself. Moreover, some vision systems and/or picking environments may not need an intervention system at all, however it is often not apparent whether one is needed until after a picking system has been deployed and is operational. Setting up an intervention system as a precautionary measure can be costly and therefore wasteful and inefficient if deployed in a picking environment which ultimately ends up not needing interventional assistance (or at least not needing interventional assistance frequently enough to justify the additional cost of setting up the intervention system).

In other areas outside of robotic picking environments, cameras or other sensor systems can be used for monitoring various environments and conditions. However these often require constant or periodic human monitoring in order to determine the status of the area being monitored and whether any issues arise. In some cases, issues arise rather infrequently, so having constant or periodic human monitoring can be excessive and inefficient. Ultimately, a large amount of time can be spent monitoring an area where very little happens.

### SUMMARY

The present invention addresses the above problems by providing observational support systems and methods for use in robotic picking and various other monitoring environments. The observational support systems may be deployed as supplemental to an existing observation or monitoring system and are operable to work in parallel or in conjunction with existing systems. The disclosed observational support systems may be stand-alone fully operational systems or may be integrated into existing systems. The inventive observational support systems and methods generally operate to obtain data associated with a monitored environment, relay the obtained data to a remote intervention system, and provide response information from the intervention system. In robotic picking applications this may comprise at least one of obtaining a query request (e.g. a trigger, a request for assistance, etc.), obtaining interventional response data associated with determining picking operations (e.g. pick instructions, pick coordinates), and providing pick information/instructions for use in controlling robotic picking operations.

The present invention provides an observational support system to supplement an existing vision/sensor system, however is completely independent of the existing vision/sensor system and requires no integration or communication with the existing vision/sensor system due in part to having its own sensor module. The observational support system can be easily installed or adapted to a wide range of picking environments to provide remote intervention assistance where there is need for such (e.g. where there is currently no interventional assistance or where existing interventional assistance is deficient in some manner). The observational support system easily interfaces with a robot for triggering and communication purposes and/or can be triggered manually or remotely as needed to provide interventional assistance. The use of such observational support systems overcomes the limitations described above.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates an exemplary system for observational support in accordance with an exemplary embodiment of the invention.

FIG. 2 illustrates an exemplary observational support system in accordance with an exemplary embodiment of the present invention.

FIG. 3 illustrates an exemplary process for providing observational support according to one embodiment of the invention.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

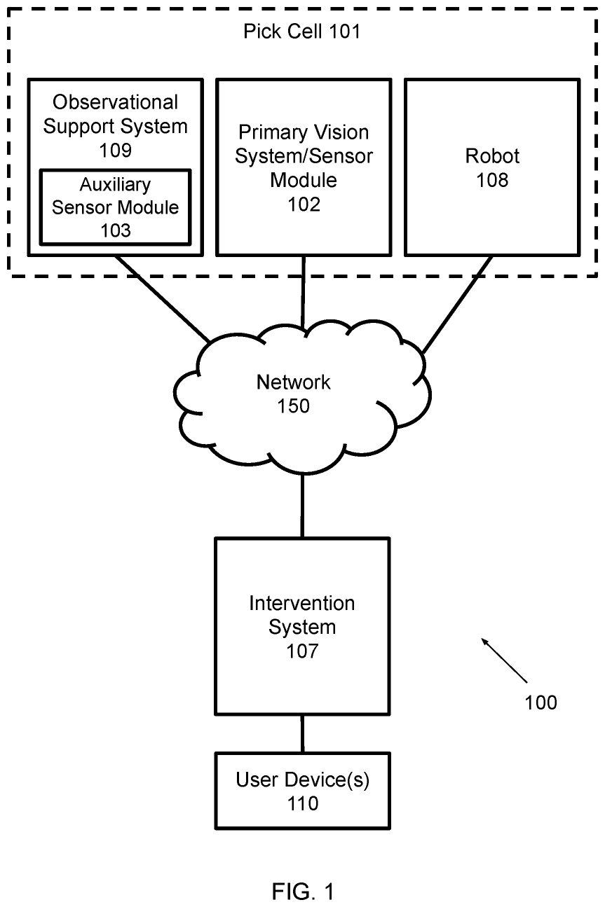

FIG. 1 illustrates an exemplary embodiment of a system for observational support 100 in robotic picking applications according to one embodiment. The system comprises observational support system 109 (which comprises an auxiliary sensor module 103), a primary vision system/sensor module 102, robot 108, each of the preceding elements associated with a pick cell 101, intervention system 107, user device(s) 110 and a network 150 over which the various systems communicate and interact. The various computing devices described herein are exemplary and for illustration purposes only. The system may be reorganized or consolidated, as understood by a person of ordinary skill in the art, to include more or fewer components and/or to perform the same tasks on one or more other servers or computing devices without departing from the scope of the invention.

As a general overview, the primary vision system/sensor module 102 obtains first data associated with (e.g. in and around) the pick cell 101, processes the obtained first data and provides first pick information (e.g. pick coordinates, pick instructions) to robot 108. The observational support system 109 is operable in parallel to primary vision system/sensor module 102 and obtains auxiliary data associated with (e.g. in and around) the pick cell 101. The observational support system 109 may receive a trigger signal initiating the acquisition of auxiliary data, where the trigger signal may generally be associated with a failure or inability of the primary vision system/sensor module 102 in determining pick control information. Observational support system 109 may provide the auxiliary data to an intervention system 107 for assistance in determining pick information. Intervention system 107 provides response data to observational support system 109 for use in providing pick information to robot 108. A detailed description of these components is discussed in more detail below.

Pick cell 101 generally represents a robotic picking environment where robotic picking operations are performed to pick and/or move objects from one location to another. The exemplary pick cell 101 comprises or is associated with at least a robot 108 (e.g. a robotic picking unit, robotic arm, etc.) and a primary vision system/sensor module 102 (note that although depicted as a single element, the primary vision system/sensor module 102 may be separate components and certain aspects of the primary vision system may be present either at the pick cell or located remotely). The pick cell 101 may be associated with automated or semi-automated robotic picking operations. The robotic picking unit 108 of pick cell 101 may comprise at least one of a robotic arm and an end effector for picking and/or moving objects within the pick cell 101, such as from a first (e.g. pick) location to a second (e.g. placement) location. Robot 108 may comprise or otherwise be associated with a controller comprising computing architecture (hardware and/or software) configured to control the robot 108. In one aspect, the controller may relay pick instructions. In one aspect, the controller may convert pick information (e.g. pick coordinates, pick points) into pick instructions actionable by the robot 108.

Primary vision system/sensor module 102 obtains first data of pick cell 101 for processing to determine picking operations to be performed by robotic picking unit 108. First sensor module 102 may obtain at least one of 2D data (e.g. image data) and 3D data (e.g. depth data) of pick cell 101 and objects located therein. This data may be referred to as pick scene data. Primary vision system/sensor module 102 processes the first pick scene data to determine pick information for use in a robotic picking operation. In general, the processing of pick scene data may comprise use of artificial intelligence (AI) to determine pick information. Pick information may comprise at least one of pickable objects, pick points or coordinates associated with pickable objects, a pick order or pick plan for picking objects, and the like. Primary vision system/sensor module 102 may provide the pick information to robot 108 for use in performing picking operations. In one aspect, primary vision system/sensor module 102 may be unable to determine pick information (in some cases without sufficient confidence) for use by robot 108. In one aspect, primary vision system/sensor module 102 may determine pick information which when used by robot 108, results in a failed picking operation (e.g. unsuccessful pick).

In some conventional systems, the inability of the primary vision system/sensor module 102 to determine appropriate pick information may result in the need for intervention depending on the configuration and capabilities of primary vision system/sensor module 102. In some cases, on-site intervention may be required which can significantly delay robotic picking operations until an individual arrives at the pick cell location and addresses the issue. For example, on-site or additional intervention may be required when primary vision system/sensor module 102 is unable to or not configured to communicate with an intervention system. In other cases, the primary vision system may be equipped for remote intervention, however the primary intervention system may be overloaded and/or provide information which results in a failed pick. In the present invention, when these scenarios arise with the primary vision system/sensor module 102, the observational support system 109 and intervention system 107 may be used to assist and/or replace the decision making process of the primary vision system/sensor module 102 so that the necessary information can be provided to robot 108 for continuing robotic picking operations. While turning to an intervention system 107 (which often involves a human-in-the-loop operator) may generally yield the most reliable outcome in these situations, it may also come with drawbacks such as a delay while waiting for the human operator to respond. In these scenarios, an auxiliary vision system (not shown), such as an AI based vision system, may provide a more immediate response suitable for addressing the issue the primary vision system/sensor module 102 was unable to (or uncertain how to) handle. Such an AI based vision system may be incorporated into the observational support system 109 and/or embodied in a separate system (either remote or local) in operable connection/communication with the observational support system 109.

Observational support system 109 is operable to obtain auxiliary pick scene data, transmit the pick scene data to interventional system 107, and receive response data from intervention system 107 for use in providing pick information to robot 108. Observational support system 109 may receive a trigger signal which initiates the functions of the observational support system. The trigger signal may be received from robot 108. For example, a trigger signal may be generated by robot 108 when robot 108 encounters an error code (such as a result of primary vision system/sensor module 102 being unable to determine appropriate pick information and/or providing pick information leading to a failed pick operation). The trigger signal may be associated with a manual trigger such as a manual triggering mechanism (such as a button, switch, touch sensor, or the like) located in or on a housing of observational support system 109 or otherwise in operable communication with observational support system 109.

Upon receiving a trigger signal, observational support system 109 may initiate pick scene data acquisition by auxiliary sensor module 103. Auxiliary sensor module 103 obtains supplemental pick scene data associated with pick cell 101 for processing to determine picking operations to be performed by robot 108. Auxiliary sensor module 103 may comprise at least one sensor including, but not limited to, at least one of a 2D image sensor (e.g. camera) and a 3D or depth sensor (e.g. depth camera). Auxiliary sensor module 103 may take the form of a CPU- or GPU-embedded camera. Auxiliary sensor module 103 may obtain at least one of 2D data (e.g. image data) and 3D data (e.g. depth data) of pick cell 101 and objects located therein. In one aspect, auxiliary sensor module 103 is located at substantially the same location as the first sensor module 102, thereby capturing second data from substantially the same perspective as the first sensor module 102. In this way, the auxiliary sensor module 103 and subsequent processing by second vision system 106 may be used to verify, grade, or otherwise analyze the processing and decisions made by primary vision system/sensor module 102. In one aspect, auxiliary sensor module 103 is located at a substantially different location than the first sensor module 102, thereby capturing second data from a substantially different perspective than the first sensor module 102. In one aspect, the auxiliary sensor module 103 gathers pick scene data that is at least partially different than that captured by the first sensor module and/or at least partially overlapping with pick scene data captured by the first sensor module. In one aspect, the auxiliary sensor module 103 and subsequent processing of the auxiliary pick scene data may be used as a backup or alternative to primary vision system/sensor module 102 when primary vision system/sensor module 102 is unable to determine appropriate pick information suitable for use by a robot in successfully picking an object. For example, when processing limitations of primary vision system/sensor module 102 are due to limitations associated with inherent aspects associated with the perspective (or point of view) of first sensor module 102, the auxiliary sensor module 103 having a different perspective (or point of view) may allow the processing limitations to be overcome without the need for intervention via an intervention system 107.

Upon obtaining auxiliary pick scene data by auxiliary sensor module 103, observational support system 109 may transmit the pick scene data to the intervention system 107. In one aspect, observational support system 109 transmits query information along with or in addition to the pick scene data. Query information may comprise an indication of expected response information to be provided via the intervention system. For example, in the context of a picking operation, query information may comprise an indication that coordinates and/or a boundary of an object (such as a box) should be identified or provided via intervention system 107 and returned to observational support system 109. Observational support system 109 upon receiving response data from intervention system 107 may send resulting pick control information to robot 108 for use in controlling the robot.

Although observational support system 109 is depicted as comprising the auxiliary sensor module 103, observational support system 109 may comprise remote or network based (e.g. server or cloud) system operable to communicate between the different system components. For example, a remote observational support system 109 may obtain, via network communication, trigger information (e.g. from robot 108), relay the trigger information to auxiliary sensor module 103 thereby initiating the acquisition of pick scene data by the auxiliary sensor module 103. The auxiliary sensor module 103 may send the obtained pick scene data to observational support system 109 which in turn sends the pick scene data to the intervention system 107. The intervention system 107 may then return response data to the observational support system 109 which in turn relays or otherwise provides resulting pick control information to the robot 108.

Intervention system 107 obtains pick scene data associated with the pick cell 101 and provides response data for use in robotic picking operations. Intervention system 107 may serve as supplemental support to the primary vision system/sensor module 102 and assist with determining pick information for use in a robotic picking operation. Intervention system 107 may obtain pick scene data from observational support system 109 or auxiliary sensor module 103. Intervention system 107 may provide the obtained pick scene data to at least one user device(s) 110 where a user (e.g. human-in-the-loop crew chief) may provide input for at least one of use in a robotic picking operation, and use to aid and/or replace pick information as determined by the primary vision system/sensor module 102. In one aspect, intervention system 107 may comprise and/or use artificial intelligence (AI) in processing of the pick scene data. The combination of the intervention system 107 with observational support system 109 allows for existing pick cell configurations to be quickly and easily adapted for remote intervention to aid a primary vision system/sensor module 102 (which may generally lack the ability to communicate with a remote intervention system or routinely encounter issues requiring intervention) without substantial overhaul or reconfiguration of the existing pick cell to accommodate a new vision system.

Although described herein with respect to a robotic picking system, the inventive concepts disclosed herein may be adapted for and/or applied to other environments other than robotic picking operations as would be apparent to one of ordinary skill in the art. For example, instead of observing and providing feedback in association with a pick cell 101, the invention may be adapted to a multitude of environments including, but not limited to, security systems/monitoring and/or threat detection, traffic monitoring, surveillance, loading dock/bay occupation status monitoring, item identification, classification and/or categorization, item sorting applications, etc. The auxiliary sensor module 103 may be configured to be at least one of a robust, industrialized, weatherized, and stand-alone system. In one aspect, the auxiliary sensor module comprises sufficient processing hardware and/or software for plug and play deployment in any of the above described applications/environments and is configured for cloud-based integration.

In these alternate applications, first and auxiliary sensor modules may comprise at least one sensor including, but not limited to, image capture sensors/cameras, video sensors/cameras, depth sensors, audio sensors (e.g. microphone), infrared sensors, thermal sensors, vibration/seismic sensors, x-ray sensors, millimeter wave scanners and other electromagnetic radiation sensors/scanners, etc. The sensor modules may be modular and configurable such that individual sensors of any type can be added to or removed from the sensor module as desired or as appropriate for a given application/environment. Depending on the particular application, information from at least one sensor may be used to trigger a query. The query can be processed to determine what additional data is needed (e.g. data from at least one of first and auxiliary sensor modules). The query and any corresponding data can be processed to provide an appropriate response which may include an intervention response from a remote intervention system (e.g. intervention system 107).

User device(s) 110 include, generally, a computer or computing device including functionality for communicating (e.g., remotely) over a network 150. Data may be collected from user devices 110, and data requests may be initiated from each user device 110. User device(s) 110 may be a server, a desktop computer, a laptop computer, personal digital assistant (PDA), an in- or out-of-car navigation system, a smart phone or other cellular or mobile phone, or mobile gaming device, among other suitable computing devices. User devices 110 may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 110 may be an electronic device including hardware, software, or embedded logic components or a combination of two or more such components and capable of carrying out the appropriate functions implemented or supported by the user device 110. For example and without limitation, a user device 110 may be a desktop computer system, a notebook computer system, a netbook computer system, a handheld electronic device, or a mobile telephone. The present disclosure contemplates any user device 110. A user device 110 may enable a network user at the user device 110 to access network 150. A user device 110 may enable its user to communicate with other users at other user devices 110.

A user device 110 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 110 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110 one or more Hyper Text Markup Language (HTML) files responsive to the HTTP request. The user device 110 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110 may also include an application that is loaded onto the user device 110. The application obtains data from the network 150 and displays it to the user within the application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to client/user devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiment, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

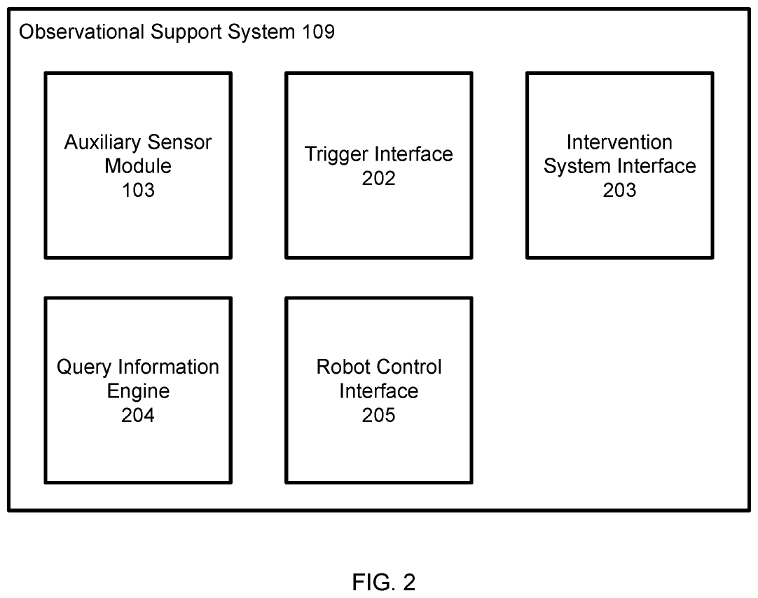

FIG. 2 illustrates an exemplary embodiment of the observational support system 109 for use in observational support in robotic picking applications (note that a similar configuration may be used for other applications outside of robotic picking wherein the robot control interface would be replaced with a corresponding interface for the given application or may not be present depending on the application). The exemplary observational support system 109 comprises auxiliary sensor module 103, trigger interface 202, intervention system interface 203, query information engine 204, and robot control interface 205. The various computing devices described herein are exemplary and for illustration purposes only. The system may be reorganized or consolidated, as understood by a person of ordinary skill in the art, to include more or fewer components and/or to perform the same tasks on one or more other servers or computing devices without departing from the scope of the invention.

Auxiliary sensor module 103 is operable to obtain supplemental or auxiliary pick scene data associated with pick cell 101 for processing to determine picking operations to be performed by robot 108. Auxiliary sensor module 103 may comprise at least one sensor including, but not limited to, at least one of a 2D image sensor (e.g. camera) and a 3D or depth sensor (e.g. depth camera). Auxiliary sensor module 103 may take the form of a CPU- or GPU-embedded camera. Auxiliary sensor module 103 may obtain at least one of 2D data (e.g. image data) and 3D data (e.g. depth data) of pick cell 101 and objects located therein. Auxiliary sensor module 103 may operate independently of other sensor modules (such as primary sensor module 102 described above). Auxiliary sensor module 103 may acquire and/or provide data in response to a trigger signal.

Trigger interface 202 is operable to receive a trigger signal indicating the need for observational support. In one aspect trigger interface 202 is configured to interface with a robot (such as robot 108 described above). In one aspect trigger interface 202 is configured to interface with a manual triggering mechanism such as a button, switch, touch sensor, or the like in operable communication with the trigger interface 202. Trigger signals received by trigger interface 202 may be used by operational support system 109 to initiate pick scene data acquisition by auxiliary sensor module 103 and subsequently send the pick scene data to intervention system (such as intervention system 107) via intervention system interface 203. In one aspect trigger signals obtained by trigger interface 202 may additionally comprise query information (e.g. generated by robot) to be relayed to the intervention system.

Intervention system interface 203 is operable to communicate with an intervention system, such as intervention system 107. Intervention system interface 203 may provide data obtained by auxiliary sensor module (e.g. pick scene data) to the intervention system. In one aspect, intervention system interface 203 provides query information associated with the data obtained by the auxiliary sensor module to intervention system 203. Intervention system interface 203 may obtain intervention response data wherein the response data comprises at least one of pick control information (e.g. pick coordinates, pick object boundaries, etc.) and pick instructions for controlling robotic picking operations.

Query information engine 204 may provide query information to be sent to the intervention system via intervention system interface 203. In one aspect, query information engine 204 may manage preconfigured query(ies) established when an observational support system is set up or installed at a pick cell location. For example, during set up of the observational support system, the query information engine 204 may be used to establish at least one query which the observational support system is expected to be used to address. Upon receipt of a trigger signal by the observational support system, the query information engine 204 may identify (e.g. based on information in the trigger signal) a corresponding query and/or provide the query to the intervention system interface 203 for transmission to intervention system. In one aspect, query information may be stored (e.g. in a database) in association with an identifier associated with the auxiliary sensor module. In one aspect, query information may be included with a trigger signal provided by robot as discussed above, in which case query information engine 204 may not be needed, configured, or used.

Robot control interface 205 may relay intervention system response data and/or convert intervention response data into appropriate pick control information for use by the robot. In one aspect, robot control interface 205 relays pick control information (e.g. pick coordinates, pick object boundaries, etc.) obtained from intervention system 107 to robot 108 for further action. In one aspect, robot control interface 205 may convert response data from an intervention system 107 into pick control information (e.g. pick instructions) suitable for use by robot 108.

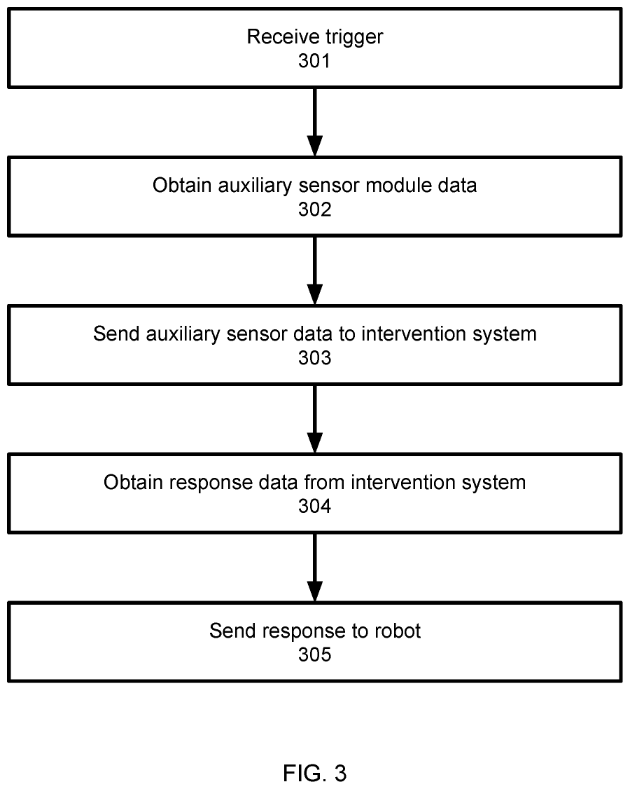

FIG. 3 illustrates an exemplary process for providing observational support according to an exemplary embodiment. The process comprises receiving a trigger 301, obtaining auxiliary sensor module data 302, sending the auxiliary sensor data to an intervention system 303, obtaining response data from the intervention system 304, and sending a response to the robot 305. The process steps described herein may be performed in association with a system such as that described in FIG. 1 and/or FIG. 2 above or in association with a different system. The steps may be reordered or consolidated, without departing from the scope of the invention, as would be apparent to one of ordinary skill in the art. Furthermore, any of the listed steps may be optional depending on the particular application of the inventive concept as would be apparent to one of ordinary skill in the art.

At step 301, the process comprises receiving a trigger. The trigger may be received by an observational support system such as observational support system 109 described above. The trigger signal may be obtained by a processor contained within a housing of (or otherwise operably connected to) the observational support system. The trigger may comprise a trigger signal received from an external source that is requesting assistance. For example, a robot may provide a trigger signal in response to encountering an issue with a pick scenario. In one aspect, the issue may be associated with a primary vision system being unable to determine appropriate pick control information for use by the robot (e.g. primary vision system fails to identify at least one of pick instructions, a pick object, pick coordinates, and pick object boundaries, or primary vision system provides pick control information which does not result in a successful pick of an object). The trigger signal may be associated with an error code associated with at least one of the primary vision system and primary sensor module. The trigger signal may be associated with a robot generated trigger signal in response to an error code associated with at least one of the primary vision system and primary sensor module. The trigger signal may be associated with a manually activated trigger, such as a manual trigger activated via interaction with a component of a housing associated with the auxiliary sensor module and/or observational support system. In one aspect, the primary vision system and/or sensor module are not configured for communication with a remote intervention system, wherein the observational support system serves to provide this functionality.

At step 302, the process comprises obtaining auxiliary sensor module data. The auxiliary sensor module data may be obtained by an auxiliary sensor module associated with the observational support system (such as described in FIG. 2 above). The auxiliary sensor module data may be obtained in response to the trigger signal. The auxiliary sensor module data may comprise pick scene data associated with a robotic pick cell. The auxiliary pick scene data may be obtained in addition to pick scene data obtained by a primary sensor module associated with a primary vision system. The auxiliary pick scene data may comprise at least one of image data, video data, and depth data. The auxiliary pick scene data may comprise data that is substantially the same as pick scene data obtained by a primary sensor module associated with a primary vision system. The auxiliary pick scene data may comprise pick scene data that is at least partially different from pick scene data obtained by a primary sensor module associated with a primary vision system. The auxiliary pick scene data may comprise pick scene data that is at least partially overlapping with pick scene data obtained by a primary sensor module associated with a primary vision system.

At step 303, the process comprises sending the auxiliary sensor data to an intervention system. The auxiliary sensor data may be sent to the intervention system via network communication. The auxiliary sensor data may be sent to the intervention system via network communication. In one aspect, sending the auxiliary sensor data may further comprise sending query information in addition to or in combination with the auxiliary sensor data. The query information may comprise information to be displayed to a user via the intervention system. The query information may comprise an indication of expected response information to be provided by the intervention system. The query information may be open ended such as simply indicating a need for assistance without requiring a particular response. The query information may be obtained from a database of previously configured query requests and associated expected response information. The query information may be obtained from a database storing query information in association with an identifier associated with the auxiliary sensor module.

At step 304, the process comprises obtaining response data from the intervention system. In one aspect, the response may be obtained from at least one of a human-in-the-loop crew chief and a supplemental artificial intelligence system (e.g. an AI system which has been trained to process sensor module data). The response data may be obtained via network communication. The response data may comprise pick control information for use in controlling a robot. The pick control information may comprise at least one of pick instructions, pick coordinates, and identification of a pick object. The response data may comprise at least one of coordinates associated with an object, object classification information, and binary response data (e.g. yes or no response data). The obtained response data may be usable by a robot for performing picking operations. The obtained response data may require conversion from a first format to a format usable by a robot in performing picking operations.

At step 305, the process comprises sending a response to the robot. Sending a response to the robot may comprise sending a response via network communication. Sending a response to the robot may comprise sending the response data obtained from the intervention system to the robot for use in controlling robot operations. Sending a response to the robot may comprise converting the response data into a format usable by a robot in performing picking operations. In one aspect, sending a response to the robot may be associated with the robot being configured to accept instructions from the observational support system when the first vision system is unable to determine appropriate pick control information for the robot.

Although described herein as a process for providing instructions to a controller associated with robotic picking operations, the process may be adapted for other observational applications where the particular data obtained and processed and the response provided would be consistent with the needs of the given application as would be apparent to one of ordinary skill in the art. For example, in non-robotic picking applications, it would not be necessary to provide pick instructions, but instead to provide application appropriate feedback sufficient to satisfy the application specific query.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, components or the like may be and/or comprise hardware and/or software as described herein.

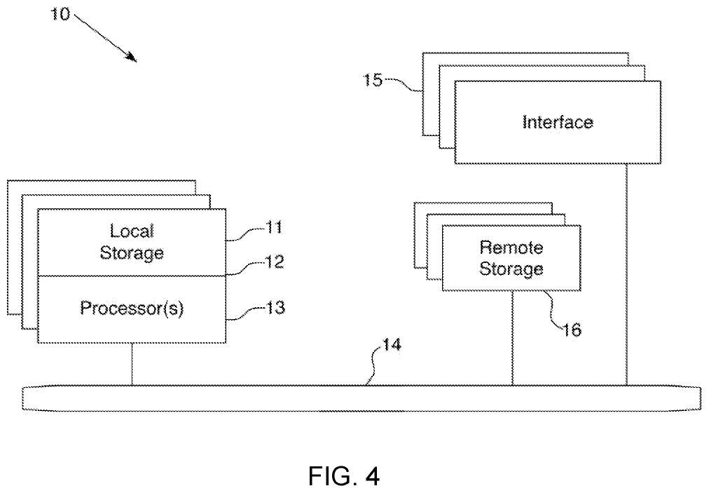

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

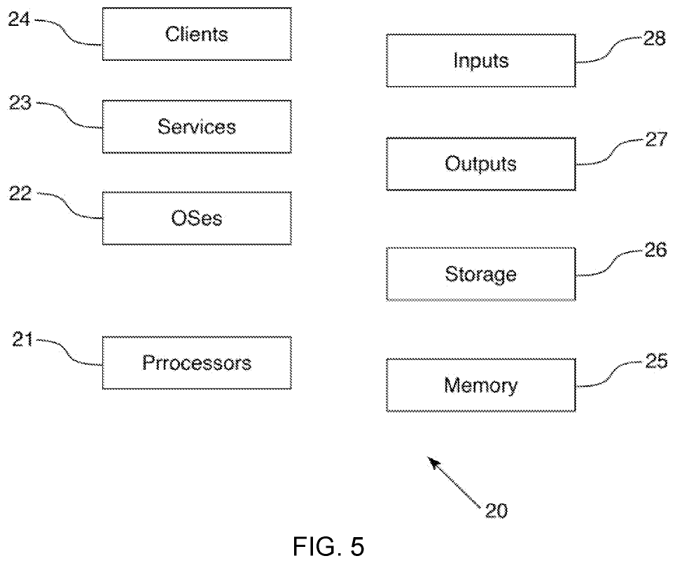

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

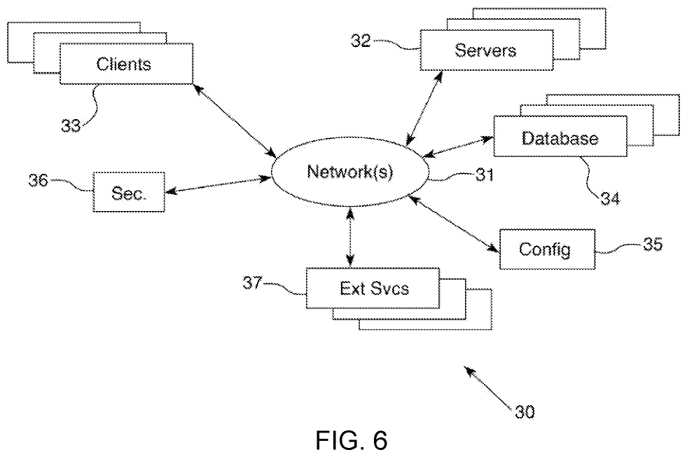

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

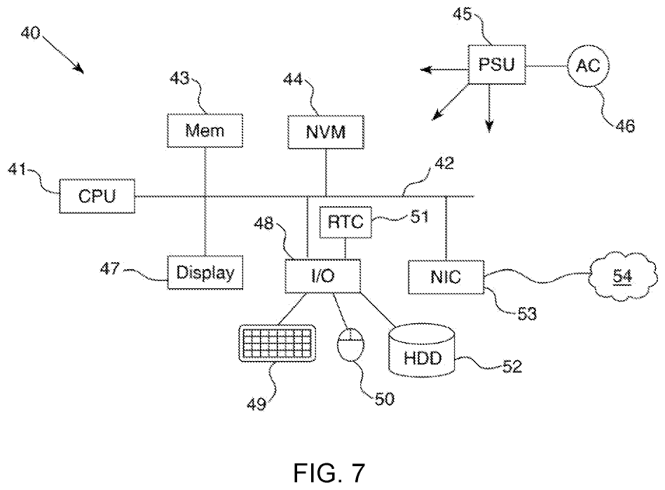

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### ADDITIONAL CONSIDERATIONS

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computer implemented method for providing observational support in a conventional robotic pick cell comprising a robot, an imaging system, and a vision system, the computer implemented method comprising:
obtaining a trigger signal, the trigger signal obtained by a processor associated with an observational support system, the observational support system positioned in relation to a robotic pick cell such that the observational support system can obtain pick scene data associated with the robotic pick cell;
obtaining, in response to the trigger signal, auxiliary pick scene data associated with the robotic pick cell, wherein the auxiliary pick scene data is obtained by an auxiliary sensor module associated with the observational support system, wherein the auxiliary pick scene data is obtained in addition to pick scene data obtained by a first sensor module associated with a first vision system, wherein both the first vision system and the observational support system are configured to provide pick control information to a robot, wherein the trigger signal is associated with the first vision system being unable to determine appropriate pick control information for the robot based on the data obtained by the first sensor module;
sending the auxiliary pick scene data obtained by the auxiliary sensor module to a remote intervention system via network communication, wherein the intervention system is operable to communicate with the observational support system;
obtaining response data from the intervention system via network communication, wherein the response data comprises pick control information which the first vision system did not provide to the robot; and
sending the response data to the robot for use in controlling the robot, wherein the robot is configured to accept instructions from the observational support system when the first vision system is unable to determine appropriate pick control information for the robot.

2. The computer implemented method according to claim 1, wherein the trigger signal is associated with an error code associated with at least one of the first vision system and first sensor module.

3. The computer implemented method according to claim 1, wherein the trigger signal is associated with a robot generated trigger signal in response to an error code associated with at least one of the first vision system and first sensor module.

4. The computer implemented method according to claim 1, wherein the trigger signal is associated with a manually activated trigger, the manually activated trigger initiated via interaction with a component of a housing associated with the auxiliary sensor module.

5. The computer implemented method according to claim 1, wherein the first vision system being unable to determine appropriate pick control information for the robot comprises at least one of a failed pick resulting from information provided by the first vision system and the first vision system failing to provide pick information usable by the robot in executing an operation.

6. The computer implemented method according to claim 1, wherein the obtained data associated with the scene comprises at least one of image data, video data, and depth data.

7. The computer implemented method according to claim 1, wherein the auxiliary sensor module comprises at least one of a camera and a depth sensor.

8. The computer implemented method according to claim 1, wherein the auxiliary sensor module gathers pick scene data that is substantially the same as pick scene data captured by the first sensor module or at least partially different than or at least partially overlapping with the pick scene data captured by the first sensor module.

9. The computer implemented method according to claim 1, wherein the intervention system is associated with at least one of a human-in-the-loop operator and a remote artificial intelligence based intervention system.

10. The computer implemented method according to claim 1, further comprising sending query information to the remote intervention system via network communication, the query information comprising information to be displayed to a user via the intervention system including at least an indication of expected response information to be provided via the intervention system.

11. The computer implemented method according to claim 1, the query information obtained from a database of previously configured query requests and associated expected response information.

12. The computer implemented method according to claim 1, the query information obtained from a database storing query information in association with an identifier associated with the auxiliary sensor module.

13. The computer implemented method according to claim 1, the response data comprising at least one of coordinates associated with an object, object classification information, and binary response data.

14. The computer implemented method according to claim 1, wherein the pick control information comprises at least one of pick instructions, pick coordinates, and identification of a pick object.

15. The computer implemented method according to claim 1, wherein sending the response data to the robot comprises converting the response data to pick instructions usable by the robot to execute a picking operation.

16. The computer implemented method according to claim 1, the robot comprising a robotic picking system.

17. The computer implemented method according to claim 1, wherein the robot is configured to accept instructions from the second vision system if there is an error code associated with the first vision system.

18. The computer implemented method according to claim 1, wherein the first vision system and first sensor module are not configured for communication with a remote intervention system.

19. A computing system for providing observational support in a conventional robotic pick cell comprising a robot, an imaging system, and a vision system, the computing system comprising:
at least one computing processor; and
memory comprising instructions that, when executed by the at least one computing processor, enable the computing system to:
obtain a trigger signal, the trigger signal obtained by a processor associated with an observational support system, the observational support system positioned in relation to a robotic pick cell such that the observational support system can obtain pick scene data associated with the robotic pick cell;
obtain, in response to the trigger signal, auxiliary pick scene data associated with the robotic pick cell, wherein the auxiliary pick scene data is obtained by an auxiliary sensor module associated with the observational support system, wherein the auxiliary pick scene data is obtained in addition to pick scene data obtained by a first sensor module associated with a first vision system, wherein both the first vision system and the observational support system are configured to provide pick control information to a robot, wherein the trigger signal is associated with the first vision system being unable to determine appropriate pick control information for the robot based on the data obtained by the first sensor module;
send the auxiliary pick scene data obtained by the auxiliary sensor module to a remote intervention system via network communication, wherein the intervention system is operable to communicate with the observational support system;
obtain response data from the intervention system via network communication, wherein the response data comprises pick control information which the first vision system did not provide to the robot; and
send the response data to the robot for use in controlling the robot, wherein the robot is configured to accept instructions from the observational support system when the first vision system is unable to determine appropriate pick control information for the robot.

20. A computer readable medium comprising instructions that when executed by a processor enable the processor to:
obtain a trigger signal, the trigger signal obtained by a processor associated with an observational support system, the observational support system positioned in relation to a robotic pick cell such that the observational support system can obtain pick scene data associated with the robotic pick cell;
obtain, in response to the trigger signal, auxiliary pick scene data associated with the robotic pick cell, wherein the auxiliary pick scene data is obtained by an auxiliary sensor module associated with the observational support system, wherein the auxiliary pick scene data is obtained in addition to pick scene data obtained by a first sensor module associated with a first vision system, wherein both the first vision system and the observational support system are configured to provide pick control information to a robot, wherein the trigger signal is associated with the first vision system being unable to determine appropriate pick control information for the robot based on the data obtained by the first sensor module;
send the auxiliary pick scene data obtained by the auxiliary sensor module to a remote intervention system via network communication, wherein the intervention system is operable to communicate with the observational support system;
obtain response data from the intervention system via network communication, wherein the response data comprises pick control information which the first vision system did not provide to the robot; and
send the response data to the robot for use in controlling the robot, wherein the robot is configured to accept instructions from the observational support system when the first vision system is unable to determine appropriate pick control information for the robot.
